(19) United States
(12) Patent Application Publication
(10) Pub. No.: US 2013/0255132 A1
(43) Pub. Date: Oct. 3, 2013

(54) Carrying case for a fishing rod

(71) Applicant: Junus Sela, Beacon, NY (US)

(72) Inventor: Junus Sela, Beacon, NY (US)

(21) Appl. No.: 13/506,117

(22) Filed: Mar. 28, 2012

(51) Int. Cl. A01K 97/08

(52) U.S. Cl. 43/26

(57) ABSTRACT

A carrying case for a fishing rod includes elongated base and cover portions; the cover portion has a substantially uniform profile over its entire length. The cover portion has a rounded profile and is hingably attached to the base portion along respective adjacent long edges thereof. In an embodiment, the fishing rod is secured inside the base portion, and a compartment is integral with the cover portion and disposed within the interior space thereof. The compartment has a door attached to the exterior of the cover portion and has a profile conforming to that of the cover portion; the compartment is thereby accessible while the cover portion is in a closed position. In another embodiment, the fishing rod is secured inside the cover portion and compartments are detachably secured inside the base portion.

### FIELD OF THE DISCLOSURE

This disclosure relates to fishing tackle, and more particularly to a fishing rod case for transporting and storing fishing rods.

### BACKGROUND OF THE DISCLOSURE

Cases for fishing rods are typically either cylindrical, with an opening cap at one end, or substantially flat with a hinged opening cover along a long edge (similar to cases for hunting bows, rifles, and the like). Cylindrical cases require the user to insert the fishing rod lengthwise into the case, risking damage to the rod. Cases with opening covers permit the user to more conveniently place the rod therein, but may have only limited interior space for other items, particularly a reel accompanying the rod. In some arrangements (for example, U.S. Pat. Nos. 5,960,950 and 6,283,288), the exterior profile of the case is made non-uniform to accommodate the particular shape of a rod/reel combination. This makes the case more difficult to carry by hand or attach to a vehicle.

There remains a need for a fishing rod carrying case with a simplified profile for ease of transport and convenient storage for both the rod and an accompanying reel or other equipment.

### SUMMARY OF THE DISCLOSURE

The present disclosure addresses the above-described need by providing a carrying case for a fishing rod including an elongated base portion and an elongated cover portion, where the cover portion has a substantially uniform profile over its entire length. According to an aspect of the disclosure, the base portion has an open top bounded by two opposing long edges and two opposing short edges; the cover portion is configured to cover the open top. The cover portion has a rounded profile and an interior space bounded by an exterior surface, two opposing long edges and two opposing short edges; the cover portion is hingably attached to the base portion along respective adjacent long edges thereof The carrying case also includes a compartment integral with the cover portion and disposed within the interior space thereof. The compartment has a door hingably attached to the exterior surface of the cover portion and has a profile conforming to that of the cover portion; the compartment is thereby accessible while the cover portion is in a closed position.

According to another aspect of the disclosure, a carrying case for a fishing rod includes an elongated base portion with an open top and a cover portion configured to cover that open top; the cover portion has a rounded profile and an interior space for disposing a fishing rod therein. The carrying case also includes a compartment disposed within the interior space of the base portion and detachably secured to an interior bottom surface thereof; the compartment has a profile conforming to that of the base portion. The carrying case may also include an interior panel, hingably attached to a side wall of the base portion, which in its lowered position rests horizontally on the top surface of the compartment. In an embodiment, the carrying case may also include vertical dividers in the base portion, to define separate, secure spaces therein.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a perspective view of a fishing rod case according to an embodiment of the disclosure, showing the case with its cover closed

FIG. 2 is a perspective view showing the fishing rod case of FIG. 1 with its cover open.

FIG. 3 is a plan view of the fishing rod case of FIG. 1 with its cover open, showing additional details of the fishing rod case.

FIG. 4 is a sectional view of the fishing rod case of FIG. 1, with its cover open.

FIG. 5 is a perspective view of a fishing rod case according to another embodiment of the disclosure, showing the case with its cover closed.

FIG. 6 is a perspective view showing the fishing rod case of FIG. 5 with its cover open.

FIG. 7 is a plan view of the fishing rod case of FIG. 5 with its cover open, showing additional details of the fishing rod case.

FIG. 8 is a sectional view of the fishing rod case of FIG. 5, with its cover open.

FIG. 9 is a perspective view of a fishing rod case as in FIG. 6 and further including a hinged interior panel, in accordance with another embodiment of the disclosure.

FIG. 10 is a perspective view of a fishing rod case as in FIG. 6 and further including interior dividers, in accordance with a further embodiment of the disclosure.

FIG. 11 is a sectional view of the fishing rod case of FIG. 9 with its cover open and including additional fishing rod storage, in accordance with another embodiment of the disclosure.

FIG. 12 is a cutaway view of a fishing rod case according to an embodiment of the disclosure, illustrating how the fishing rod case may be secured to a roof rack on a vehicle.

### DETAILED DESCRIPTION

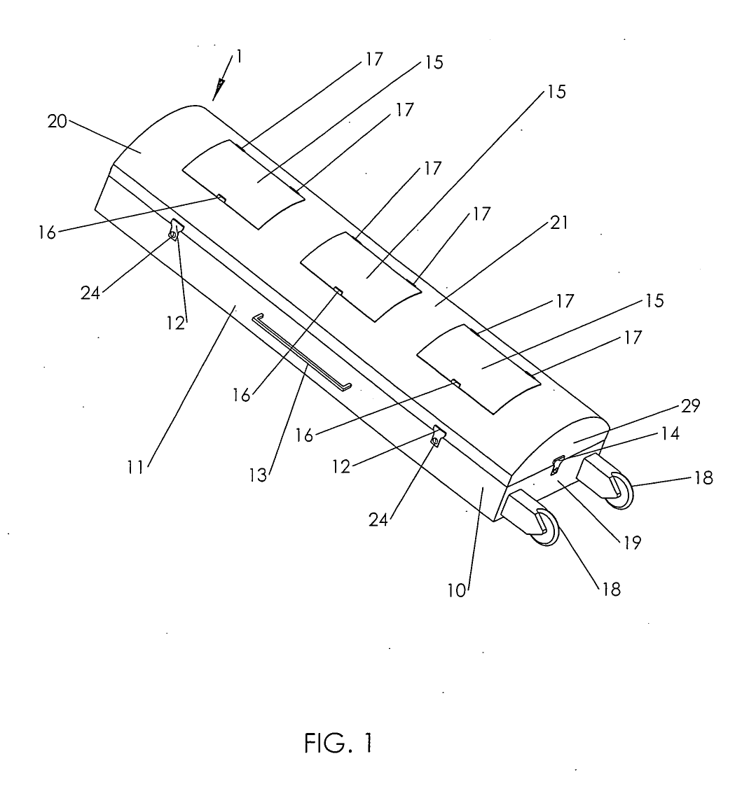

FIG. 1 shows a fishing. rod case 1 according to an embodiment of the disclosure, in its closed position. The base portion 10 of case 1 is an elongated rectangle with a handle 13 approximately in the center of a long side 11, wheels 18 mounted on one of the short sides 19, and at least one handle attached to the opposite short side (not visible in FIG. 1). The base portion 10 has a rectangular profile while the cover portion 20 has a rounded profile; in this embodiment, each short end 29 of the cover portion 20 is a section of a circle. Cover portion 20 is attached to the base portion 10 by hinges along the long side opposite side 11. When cover portion 20 is in the closed position, latches 12, 14 (on the long side and short side respectively) secure the cover portion 20 to the base portion 10. The case may also be provided with a lock 24 for locking cover portion 20 in the closed position.

Case 1 also provides storage for items other than the fishing rods, in one or more compartments which may be opened without the need to open the cover. In this embodiment, three compartments for storing fishing tackle are provided in the interior of cover portion 20; these compartments are accessible from the exterior of the case 1 via access doors 15. Doors 15 are attached to the outer surface 21 of cover portion 20 by hinges 17, and secured to the cover portion by latches 16 when the doors are in the closed position. Doors 15 have a profile conforming to that of cover portion 20 so that when doors 15 are closed, they are substantially flush with surface 21. As shown in FIG. 1, cover portion 20 has a substantially uniform profile for its entire length.

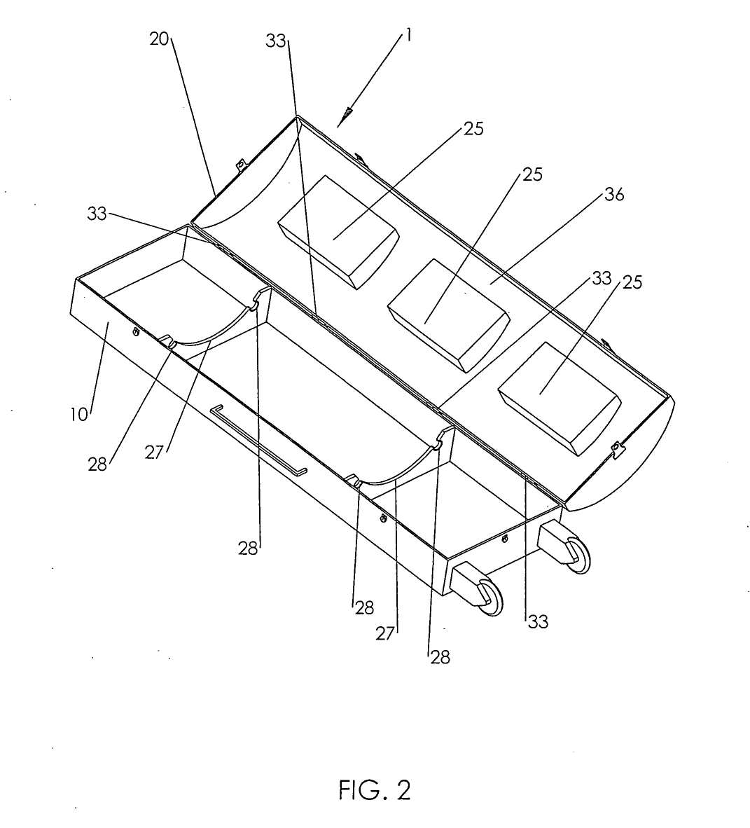

FIG. 2 shows the case of FIG. 1 in its open position. Cover portion 20 is attached to base portion 10 by hinges 33. In this embodiment, there are four separate hinges spaced along the long sides of the base and cover portions, connecting their adjacent long edges. Alternatively, a single elongated hinge may be provided. Three compartments 25 are disposed in the interior of cover portion 20; as shown in FIG. 2, the exterior surfaces of the compartments 25 are integral with the interior surface 36 of the cover portion 20.

In this embodiment, the fishing rods are secured in the interior of the base portion 10. At least two structures 270 secured to the interior bottom surface of base portion 10, with indentations 28 at the top edge thereof, are spaced along the length of base portion 10. In this embodiment, structures 27 are configured as partitions across the base portion, serving as stiffening members for the base portion. The fishing rods are fitted into the indentations 28. The indentations preferably include a clip arrangement or have a resilient material contacting the fishing rod, so that the fishing rod is held positively when installed in the case. (The fishing rod case 1 is typically sized to hold 4 to 6 fishing rods; for clarity, the partitions 27 in FIG. 2 are shown configured to hold only two rods.)

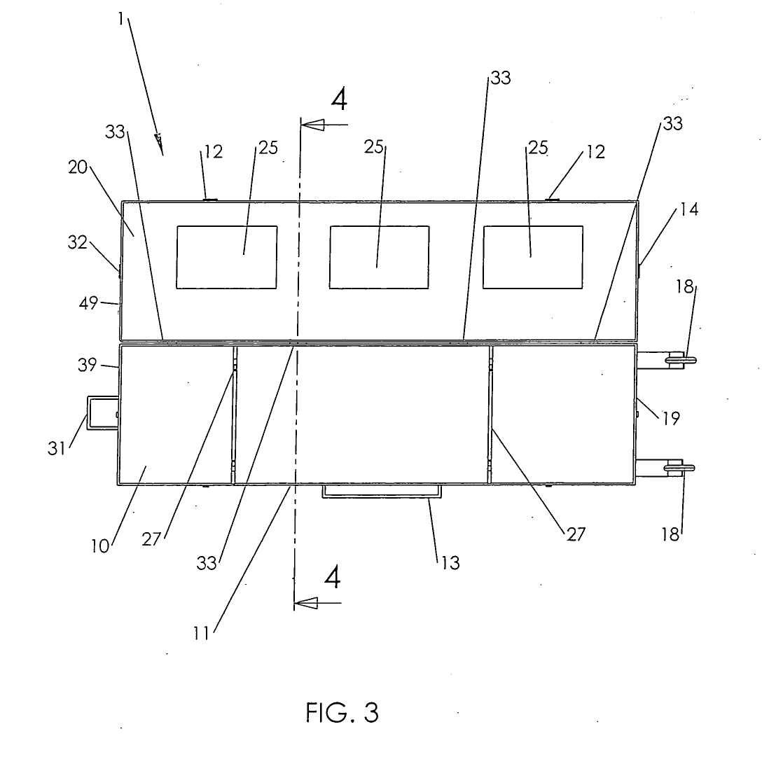

FIG. 3 is a plan view of case 1 fully opened, showing cover portion 20 attached to base portion 10 by hinges 33. The opposing short sides of the base portion and cover portion have latches 14, 32 while the long side 11 of the base portion, opposite the hinges 33, has latches 12. In this embodiment, handles 31 are attached to the short ends 39, 49 of the base portion and cover portion, opposite short ends 19, 29; that is, handles 31 are opposite wheels 18. Handles 31 may advantageously be telescoping so that a user may comfortably roll the case using the wheels. The interior surfaces of compartments 25 (their bottom surfaces when the cover 20 is closed) are shown in FIG. 3. Also shown are the edges of partitions 27.

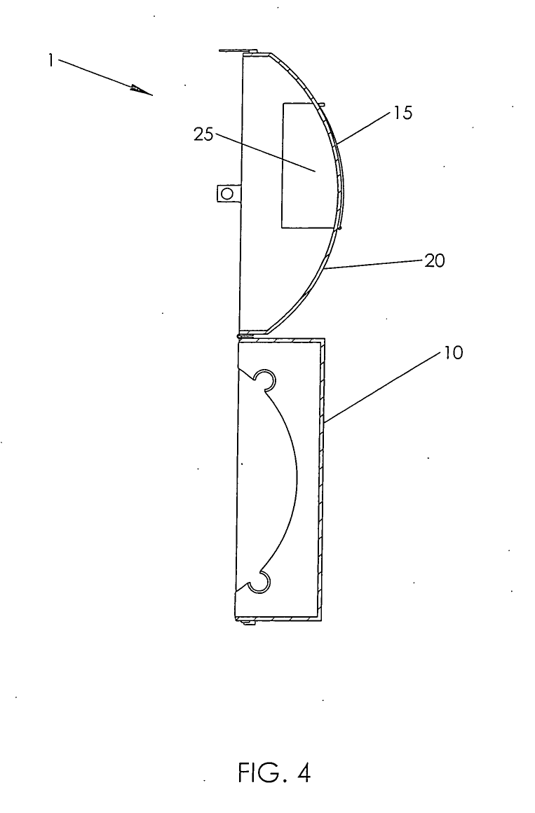

FIG. 4 is a cross-section view of case 1. Base portion 10 is sized to hold 4 to 6 fishing rods; typically a rod is carried in case 1 with its reel detached (the reel advantageously stored in one of the compartments 25). Tackle compartment 25 is integral with cover portion 20 and is accessed from the outside of the case by door 15. As shown in FIG. 4, compartment 25 has a profile such that the interior space thereof is entirely contained within the interior space of cover portion 20. Accordingly, the tackle compartment does not interfere with the fishing rods in base portion 10 when the cover is closed.

The fishing rod case 1 is advantageously made of a durable plastic so that it is crushproof and waterproof. The rounded profile of the cover makes it suitable for carrying on the outside of a vehicle, e.g. on a roof rack.

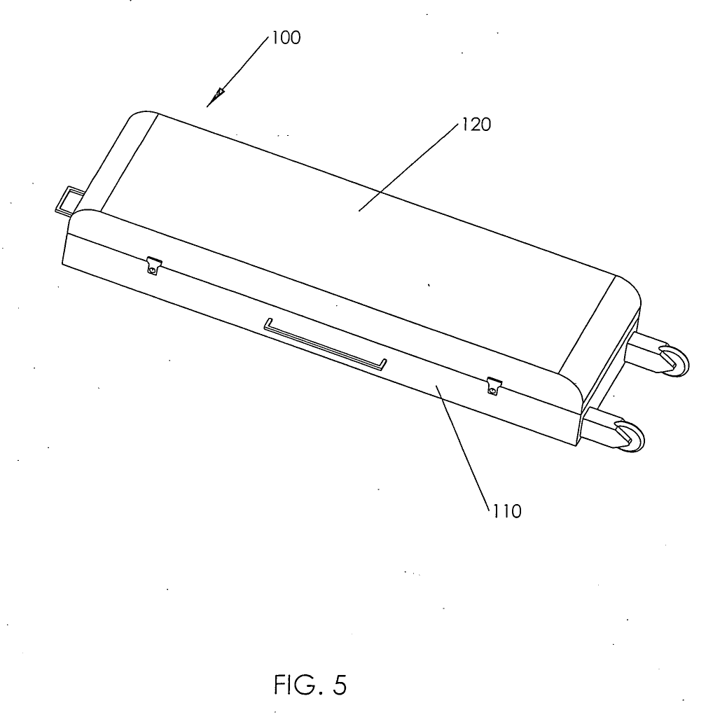

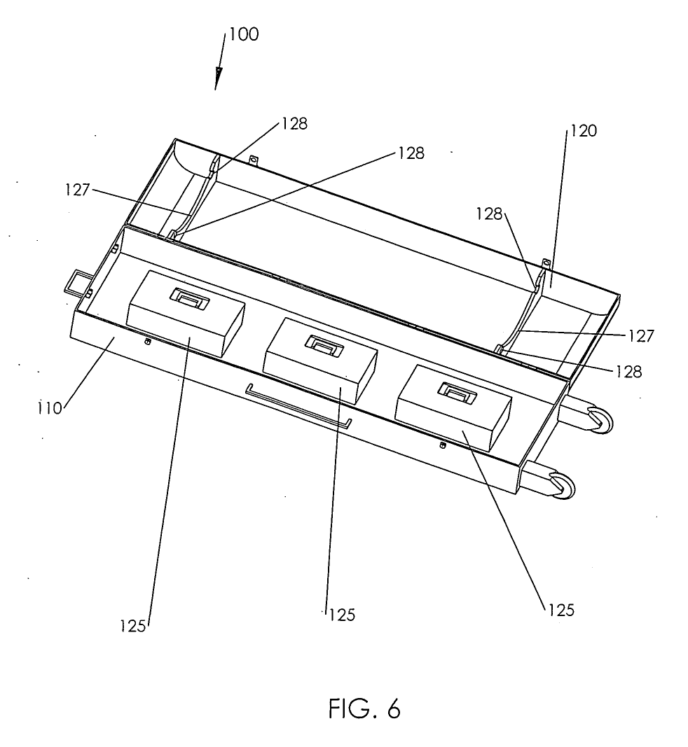

FIG. 5 shows a fishing rod case 100 according to another embodiment of the disclosure. Cover portion 120 has a smooth surface to minimize wind resistance when the case is carried outside a vehicle (for example, secured to a roof rack). Base portion 110 has exterior features similar to the previous embodiment. FIG. 6 shows case 100 in its open position. The interior of cover portion 120 has structures 127 with indentations 128 in the edges thereof As in the previous embodiment, the structures are formed as partitions and the indentations are configured with clips, resilient material or the like to positively hold the fishing rod in the indentations 128. Partitions 127 have curved edges conforming to the profile of cover portion 120. (The fishing rod case 100 is typically sized to hold 4 to 6 fishing rods; for clarity, the partitions in FIG. 6 are shown configured to hold only two rods.)

Storage compartments 125 are located in the base portion 110. Compartments 125 are detachably secured to the inside surface of bottom portion 110 with latches hooks, straps or any other convenient arrangement. In this embodiment, compartments 125 may be removed from the case. Each compartment may have one or more carrying handles at the top or sides thereof. Since compartments 125 are secured to the bottom of the carrying case, they are not turned upside down when the cover is opened, as occurs with the integral compartments 25 of case 1.

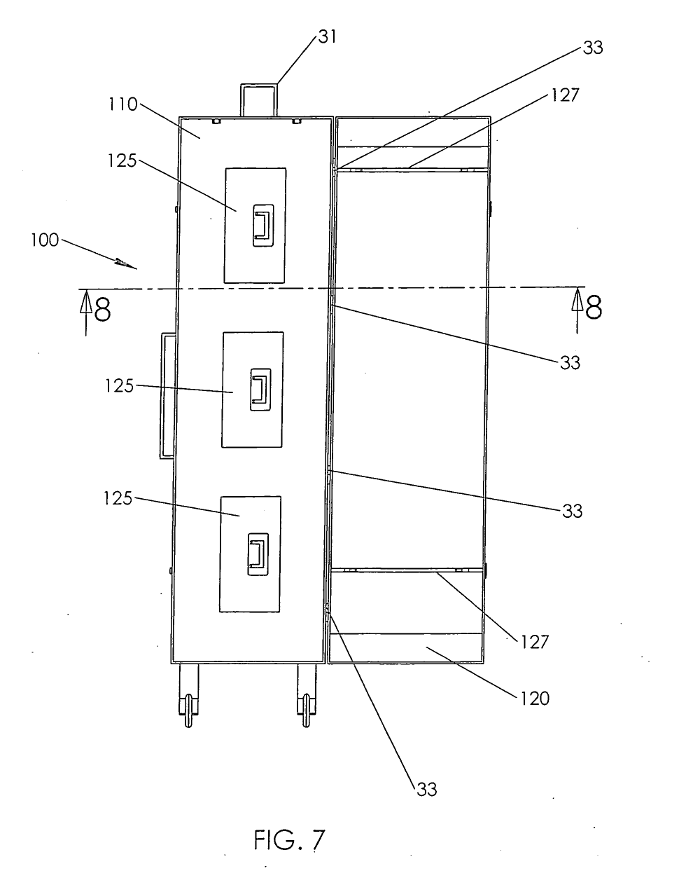

FIG. 7 is a plan view of case 100 fully opened, showing cover portion 120 attached to base portion 110 by hinges 33. Case 100 includes latches, handles and wheels as in the previous embodiment. The top surfaces of removable compartments 125 are shown in FIG. 3. Also shown are the edges of partitions 127.

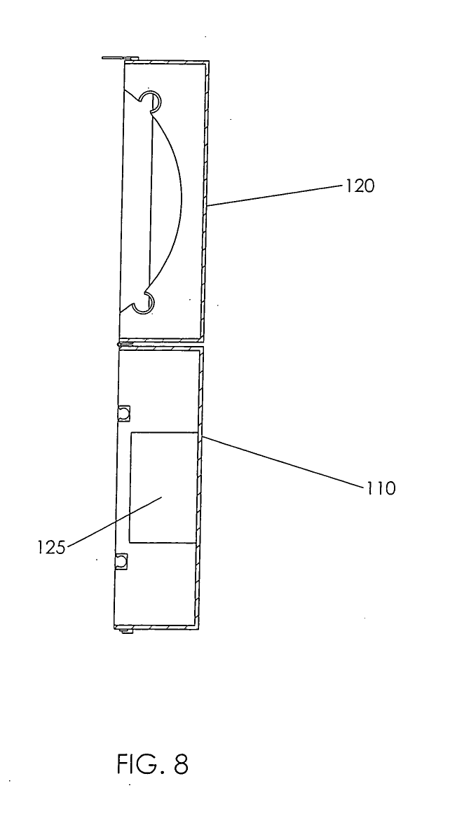

FIG. 8 is a cross-section view of case 100. Compartment 125 has a profile such that it is entirely contained within the interior space of base portion 110. Accordingly, the compartment does not interfere with the fishing rods in secured in cover portion 120 when the cover is closed.

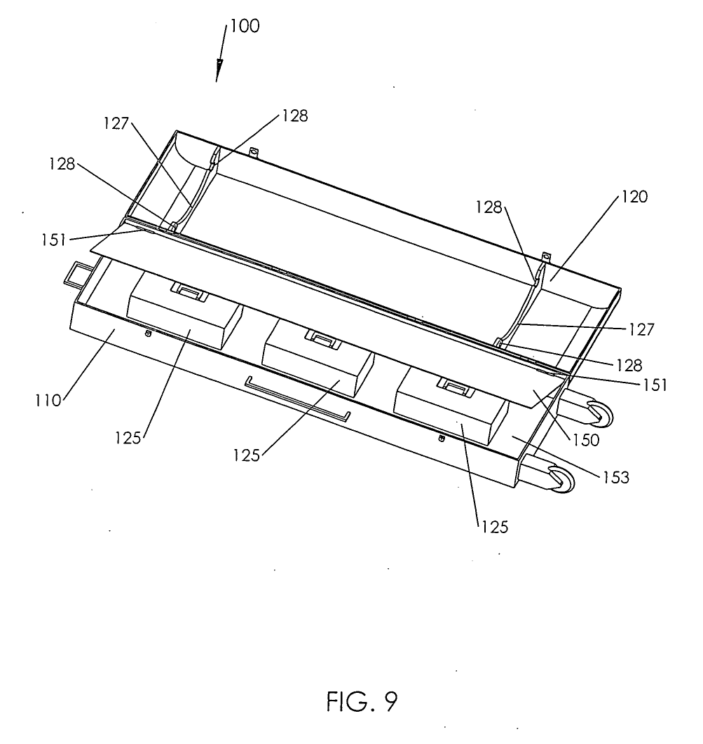

FIG. 9 shows a fishing rod case according to another embodiment of the disclosure. This fishing rod case has the general features of the fishing rod case of FIG. 6, and also includes a hinged interior panel 150, secured to one side of the base portion 110 with hinges 151. Panel 150 is shown in a raised position in FIG. 9. In its lowered position, panel 150 is parallel to the bottom of base portion 110 and rests on the top surfaces of compartments 125. In this embodiment, the compartments 125 may be provided with carrying handles either on their sides, or recessed with respect to their top surfaces, so that panel 150 rests on a uniform surface on top of compartments 125. Panel 150 may be secured in its lowered, horizontal position with suitable latches, clips, etc. (not shown in FIG. 9). When secured in its lowered position, panel 150 defines a closed space 153 surrounding compartments 125 in the interior of base portion 110. Items in space 153 will not spill out of case 100, even if the case is turned upside down and the cover portion 120 is opened.

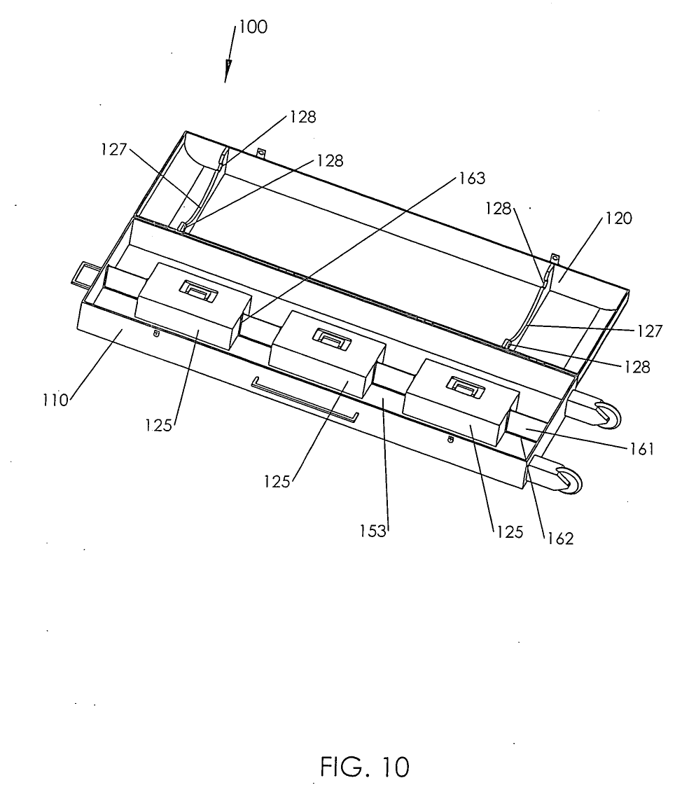

In another embodiment, base portion 110 has vertical dividers 161 in its interior, as shown in FIG. 10. Dividers 161 fit between the compartments 125, and between the wall of the case and a neighboring compartment. The bottom of base portion 110 may have grooves or channels 162 formed therein, to receive the lower edge of a divider panel 161. Similarly, compartments 125 may have grooves or channels 163 formed in their sides to receive a side edge of a divider panel 161. When used in conjunction with hinged panel 150, dividers 161 define separate, secure spaces within space 153 inside base portion 110. Depending on the number and spacing of the grooves or channels, dividers 161 may be used to define spaces of a variety of sizes. Grooves 162 are shown extending longitudinally along the bottom of base portion 110; additional grooves and dividers (not shown) may be provided in the transverse direction, to form small spaces within space 153 as desired. Small items may thus be stored securely and organized neatly, even when the case 100 is carried, tipped over, or even turned upside down.

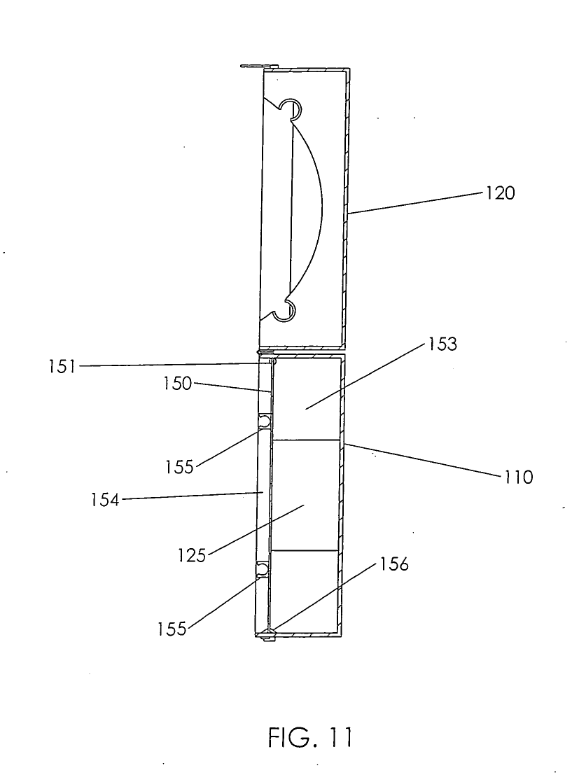

FIG. 11 is a cross section view of the case of FIG. 9, showing panel 150 in its lowered (closed) position. Panel 150 is connected to a wall of the case by hinges 151, and rests on the top surfaces of compartments 125. Panel 150 may be secured in the lowered position using a clip arrangement 156, shown schematically in FIG. 11. Additional items may be stored in space 154 above the top surface of panel 150; for example, fishing rods may be secured to panel 150 using clips 155. FIG. 11 illustrates an arrangement for storing two rods, in addition to the rods stored within the cover portion 120.

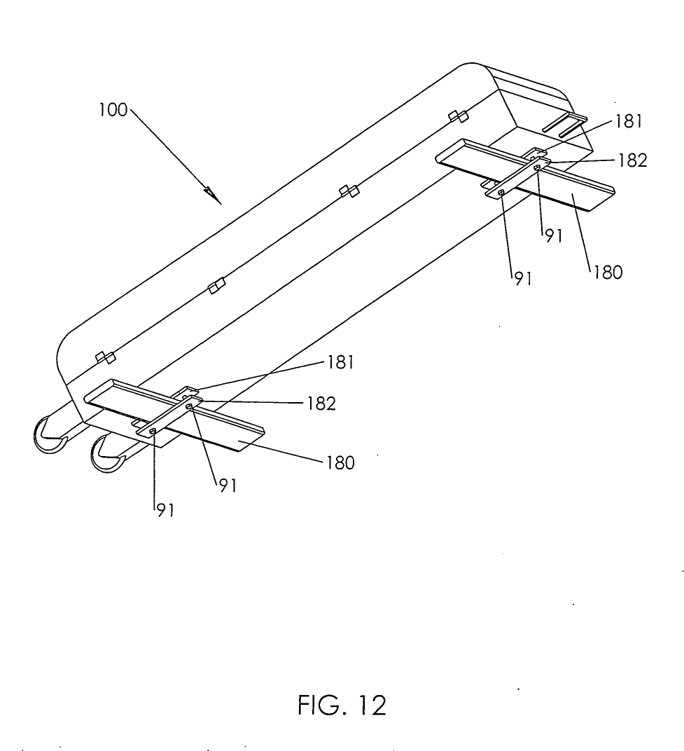

FIG. 12 schematically illustrates securing a fishing rod case to the roof rack of a vehicle. Case 100 is typically ling enough to span two parallel crosswise members 180 of a roof rack; case 100 is thus typically mounted longitudinally on the vehicle's roof. At each end of the case, at least two holes 91 are formed in the bottom of the base portion, aligning with holes in plates 181, 182 which capture member 180. Case 100 is thus positively secured to member 180 by bolting plates 181, 182 to each other and to the bottom of case 100.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. A carrying case for a fishing rod, comprising:
an elongated base portion for disposing a fishing rod therein, the base portion having an open top bounded by two opposing long edges and two opposing short edges;
a cover portion configured to cover said open top, the cover portion having a rounded profile and an interior space bounded by an exterior surface, two opposing long edges and two opposing short edges, the cover portion hingably attached to the base portion along respective adjacent long edges thereof; and
a compartment integral with the cover portion and disposed within the interior space thereof, the compartment having a door hingably attached to the exterior surface of the cover portion and having a profile conforming to that of said cover portion, the compartment thereby being accessible while the cover portion is in a closed position,
wherein the cover portion has a substantially uniform profile over the length thereof.

2. A carrying case according to claim 1, wherein the base portion further includes a handle on at least one of a long side and a short side of the base portion.

3. A carrying case according to claim 2, wherein a telescoping handle is on a short side of the base portion, and further including a wheel attached to the opposing short side of the base portion.

4. A carrying case according to claim 1, wherein the compartment has an interior space located entirely within the interior space of the cover portion.

5. A carrying case according to claim 1, wherein at least the base portion and cover portion are formed of a durable plastic.

6. A carrying case according to claim 1, wherein one long edge of the base portion is attached to the cover portion by a hinge, and the opposing long edge of the base portion includes a latch for securing to the cover portion.

7. A carrying case according to claim 1, further comprising a structure secured to an interior bottom surface of the base portion and configured to positively hold the fishing rod.

8. A carrying case according to claim 7, wherein said structure is a partition secured to opposing long sides of the base portion.

9. A carrying case according to claim 7, wherein said structure has an indentation formed therein for receiving the fishing rod.

10. A carrying case for a fishing rod, comprising:
an elongated base portion having an open top bounded by two opposing long edges and two opposing short edges;
a cover portion configured to cover said open top, the cover portion having a rounded profile and an interior space for disposing a fishing rod therein, the cover portion bounded by an exterior surface, two opposing long edges and two opposing short edges, the cover portion hingably attached to the base portion along respective adjacent long edges thereof; and
a compartment disposed within the interior space of the base portion and detachably secured to an interior bottom surface thereof, the compartment having a profile conforming to that of said base portion,
wherein the cover portion has a substantially uniform profile over the length thereof.

11. A carrying case according to claim 10, wherein the base portion further includes a handle on at least one of a long side and a short side of the base portion.

12. A carrying case according to claim 11, wherein a telescoping handle is on a short side of the base portion, and further including a wheel attached to the opposing short side of the base portion.

13. A carrying case according to claim 10, wherein the compartment has an interior space located entirely within the interior space of the base portion.

14. A carrying case according to claim 10, wherein at least the base portion and cover portion are formed of a durable plastic.

15. A carrying case according to claim 10, wherein one long edge of the base portion is attached to the cover portion by a hinge, and the opposing long edge of the base portion includes a latch for securing to the cover portion.

16. A carrying case according to claim 10, further comprising a structure secured to an interior surface of the cover portion and configured to positively hold the fishing rod.

17. A carrying case according to claim 16, wherein said structure is a partition having a curved edge conforming to the profile of the cover portion.

18. A carrying case according to claim 17, wherein said structure has an indentation formed therein for receiving the fishing rod.

19. A carrying case according to claim 10, further comprising a panel hingably connected to the base portion at an interior side surface thereof, so that in a lowered position the panel rests on a top surface of said compartment.

20. A carrying case according to claim 10, further comprising a vertical divider disposed between neighboring compartments within the base portion and/or between the compartment and a side wall of the base portion.
